(19) United States
(12) Patent Application Publication
(10) Pub. No.: US 2016/0241617 A1
(43) Pub. Date: Aug. 18, 2016

(54) Media System

(71) Applicants: John Jelley, Middlesex (GB); Ian Shimmings, Wantage (GB); Andreas Andersson, Stockholm (SE); Michael Cutler, Middlesex (GB); Joel Newman, Wokingham (GB)

(72) Inventors: John Jelley, Middlesex (GB); Ian Shimmings, Wantage (GB); Andreas Andersson, Stockholm (SE); Michael Cutler, Middlesex (GB); Joel Newman, Wokingham (GB)

(73) Assignee: BRITISH SKY BROADCASTING LIMITED, Isleworth, MIddlesex (GB)

(21) Appl. No.: 14/001,670

(22) PCT Filed: Feb. 22, 2012
(86) PCT No.: PCT/GB2012/050399

§ 371 Date: Apr. 8, 2016

(30) Foreign Application Priority Data
Feb. 25, 2011 (GB) 1103244.8

(51) Int. Cl. H04L 29/06; G06F 3/0482; G06F 3/0484; H04L 29/08

(52) U.S. Cl. CPC H04L 65/4084; H04L 65/602; H04L 67/42; H04L 65/608; H04L 67/02; G06F 3/0482; G06F 3/04842; G06F 2203/04803

(57) ABSTRACT

Streaming media is provided over a network using a non-streaming-specific transfer protocol, in which a media stream is stored on a server as multiple individual media files, and a playlist is provided indicating which media files are required for output of a specific part of the media stream; wherein multiple different playlists are provided to respective different media streaming clients, in response to requests relating to corresponding different parts of the media stream. A user interface is provided on the client device, in which an interactive media event is displayed including streaming media, and secondary media content.

### FIELD OF THE INVENTION

The present invention relates to a media system, particularly but not exclusively for streaming media such as video to client devices, and/or for displaying media content using an interactive interface.

### BACKGROUND OF THE INVENTION

Streaming protocols such as Real-time Streaming Protocol (RTSP), Real-time Transport Protocol (RTP) and Real-time Transport Control Protocol (RTCP) have been designed specifically for streaming media over networks, such as the Internet. However, such protocols may cause problems at intermediate nodes such as firewalls and proxy servers. As an alternative, HLS (HTTP Live Streaming) has been developed, by Apple Inc., as a means for streaming media using standard HTTP as a transport protocol, which is therefore reliable across most forms of Internet connectivity.

In HLS, a video stream is divided into ‘chunks’, each comprising a small downloadable file. An associated playlist file is generated, comprising metadata defining how the chunks are to be output to reconstruct the video stream. The playlist file is updated as new chunks are added to the stream, and the new playlist file is requested periodically by the streaming clients. Details of HLS are disclosed in patent publication WO-A-2010/078281 and IETF draft “HTTP Live Streaming” version 5, 19 Nov. 2010.

As an alternative to live streaming, a complete media file may be downloaded to a local device, and may be played back from any point in the file. However, this functionality is not possible with an HLS media stream, since the associated playlist only allows the stream to be played ‘live’, that is at the point to which media content has most recently been added. Only once a live media stream has been closed may its contents be made available as a downloadable media file. However, limitations may be placed on the size of media that can be downloaded as a single file. For example, the current ‘Requirements for Apps’ by Apple Inc. limit the size of downloadable video to 10 minutes, or 5 MB of data in a 5 minute period; above that size, the video must be delivered by HLS (see ‘HTTP Live Streaming Overview’, Apple Inc., 15 Nov. 2010).

### STATEMENTS OF THE INVENTION

According to one aspect of the present invention, there is providing a method of, and system for providing streaming media over a network using a non-streaming-specific transfer protocol, in which a media stream is stored on a server as multiple individual media files, and a playlist is provided indicating which media files are required for output of a specific part of the media stream; wherein multiple different playlists are provided to respective different media streaming clients, in response to requests relating to corresponding different parts of the media stream.

The different parts may relate to different time points or different predetermined segments within the media stream, such that the media streaming clients are able to output either the stream at its current point (for example as a live stream), or at a previous point; this may enable rewinding, fast forwarding, and/or skipping to specified points of a live stream.

The multiple different playlists may be provided from a database which receives as input a periodically updated current playlist and thereby stores a partial or complete historical index of the media files comprising the stream.

At least one of the multiple different playlists may comprise a closed playlist, identifying an end point in a segment of the media stream, wherein the media stream is an open stream.

The server may be responsive to requests relating to a specified earlier absolute or relative time. The requests may specify the duration of the corresponding part of the media stream. The server may further be responsive to search requests to identify a segment, for example by keyword, time and/or popularity.

The segments may be predetermined by means of a user interface for manual definition of segments.

According to another aspect of the invention, there is provided a media streaming client arranged to generate a request and receive a corresponding playlist as recited above. The client may include a user interface allowing a user to select the part of the media stream to be requested and output by the client. The user interface may indicate whether the output part of the media stream is current, or live.

According to another aspect of the invention, there is provided a media data structure comprising a primary module and one or more associated secondary modules, the primary module comprising video content and associated metadata, and each secondary module comprising media content associated with the video content.

The media data structure is preferably displayable on a media device by displaying simultaneously the video content as a primary display and at least a part of the media content of the associated secondary module(s) as a secondary display. At least one of the displays of the secondary module(s) may be selected so as to display the media content of the secondary module as a primary display. The primary module may simultaneously be displayed as a secondary display. A user may navigate between displays of different said secondary modules as said primary display. A user may share one or more of the secondary modules with one or more other users.

A plurality of said primary modules may be displayed simultaneously, in a grid and/or a timeline format. The primary modules may be independent of each other, or linked, for example by metatags.

### BRIEF DESCRIPTION OF THE DRAWINGS

There now follows, by way of example only, a detailed description of embodiments of the present invention, with reference to the figures identified below.

FIG. 1 is a schematic diagram of a conventional HLS implementation.

FIG. 2 is a schematic diagram of a live media streaming system according to an embodiment of the present invention.

FIG. 3 is a more detailed schematic diagram in the embodiment.

FIG. 4 is a diagram of an event data structure in the embodiment.

FIG. 5 is a diagram of a CMS editing screen in the embodiment.

FIG. 6 is a storyboard of a client user interface in the embodiment.

FIG. 7 is a screenshot of a grid screen of the user interface.

FIG. 8 is a screenshot of a timeline screen of the user interface.

FIG. 9 is a screenshot of an event home screen of the user interface.

FIGS. 10.1 to 10.6 are screenshots of single module screens of the user interface.

FIG. 10.7 is a screenshot of a single module screen with a feed overlay.

FIG. 10.8 is a screenshot of a backstory screen of the user interface.

FIG. 11 is a schematic diagram of a computer system in an embodiment.

### DETAILED DESCRIPTION OF THE EMBODIMENTS

Conventional HLS Implementation

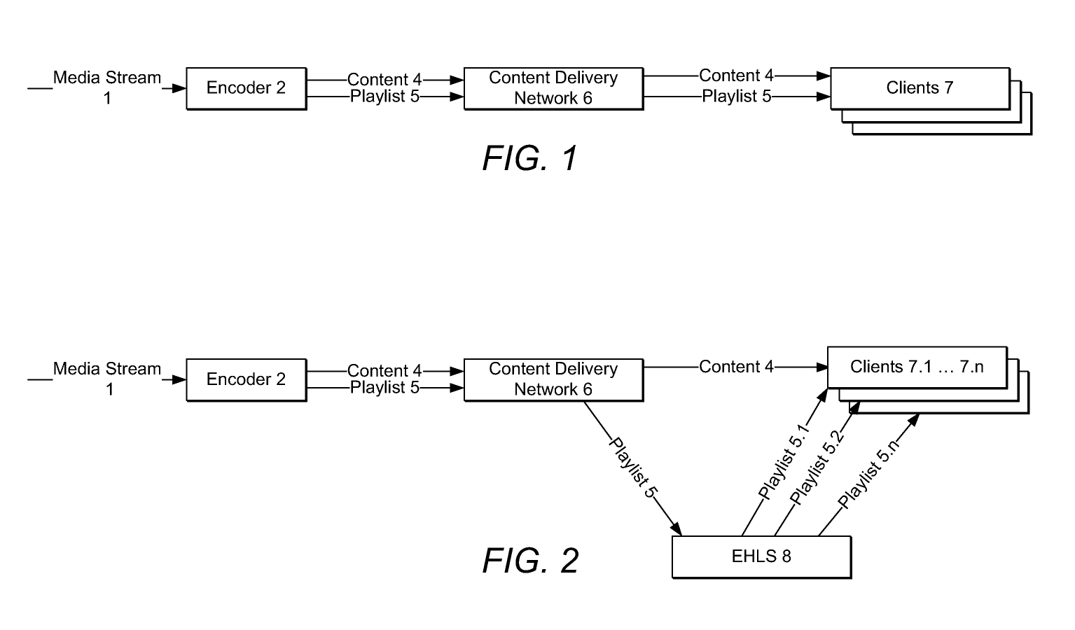

FIG. 1 shows schematically the main components of a conventional HLS implementation. One or more media streams 1 from a media source are provided to an encoder 2, comprising a media encoder and a stream segmenter. The media encoder encodes the media streams using an MPEG-2 delivery format, and an encoding format supported by clients 7, such as H.264 or MPEG-4 video or HE-AAC audio.

The stream segmenter divides each MPEG-2 stream into chunks, saved as a series of .ts media content files. The media content files may be encrypted, in which case the stream segmenter also creates associated key files.

For each media stream, the stream segmenter also creates a playlist file 5, in .M3U8 format, which forms an index of the available media content files. As new content arrives in the media stream 1, new media content files are generated and the playlist file is updated to reference the new content files. If the media stream 1 has finished, the encoder adds an ‘ENDLIST’ tag to the playlist, which is then referred to as ‘closed’. A playlist without such a tag is referred to as ‘open’.

The encoder 2 may generate variants of the media stream, with different coding rates, each having a different set of media content files. In that case, the playlist 5 indexes each of the variant sets.

The content files 4 and the playlist file 5 are output from the encoder 2 to a Content Delivery Network (CDN) 6, typically a web server, that provides the playlist file 5 to clients 7 at a specified URL, and provides the media content files 4 requested by the clients 7. The clients 7 are connected to the CDN 6 via a network, such as the Internet, typically over a wireless network such as a GPRS, 3G or WiFi network.

Each of the clients 7 comprises a media player, typically a software application. To play a media stream, the media player fetches the playlist 5 from a URL identifying that stream. The playlist 5 specifies the locations of the available media files 4, which the media player then downloads in sequence. Once the media player has buffered a sufficient number of sequential media files 4, it then begins to output the media stream, by decoding the media content and presenting the content to the user.

The media player periodically re-requests the playlist 5, to obtain the locations of new media files 4 added to the stream, and downloads the new media files 4 for output. This process continues until the media player encounters the ‘ENDLIST’ tag, whereupon the media player completes the output of the available media files, and then finishes outputting the stream.

Where variant content files 4 are available, the media player requests content files 4 from the variant set most suited to network conditions, such as available bandwidth. The media player may switch between variant sets within a media stream, in response to changes in detected network conditions.

An important feature of conventional HLS is that all clients 7 receive the same playlist 5, and the time window of available content 4 is very short, typically only a few minutes. Hence, applications are limited to displaying essentially the live media stream.

Enhanced Live Media Streaming—Overview

An improvement of conventional HLS, according to an embodiment of the invention, is shown schematically in FIG. 2. In this embodiment, an ‘Enhanced HLS Server’, or EHLS 8, acts as a client to the CDN 6 and receives the periodically updated playlist 5. From the periodically updated playlist 5, the EHLS 8 compiles an expanded playlist for some or all of the media stream up to the current, live content. The clients 7.1 . . . n are each able to request from the EHLS 8 a corresponding customised playlist 5.1 . . . n comprising any part of the expanded playlist. The clients 7.1 . . . 7.n then download the media files 4 indexed by their respective customised playlists 5.1 . . . 5.n from the CDN 6.

Each client 7.1 . . . 7.n may request a customised playlist relating to a time earlier than the current time, thus allowing the associated media player to rewind or skip back to an earlier time in the live media stream, and to revert back to the current live media stream. In this way, the media player is able to combine live streaming with random access to any part of the video stream, which was previously only available with complete downloaded clips.

The media player is similar to a conventional HLS media player, except that it retrieves the customised playlist from the URL of the EHLS 8, rather than the CDN 6. Also, the media player indicates the particular time within the media stream for which the customised playlist is required, as detailed below. The media player may indicate to the user whether the current output media stream is ‘live’ (i.e. referenced to the current time), or previous to the current time.

In addition to the customised playlists, the EHLS 8 may also provide a live playlist, similar to the playlist 5 provided by the CDN 6.

The EHLS 8 may also create a modified playlist having a different current time or end point from the playlist 5 provided by the CDN. For example, where the playlist 5 is an ‘open’ playlist, the EHLS 8 may provide a modified, ‘closed’ playlist, having a defined end point. Alternatively, the modified playlist may be an open playlist, but with the current time reference earlier than the current time of the playlist 5. The modified playlist(s) may be requested by any of the clients 7.1 . . . n. The end point and/or current time may be controlled manually, or by automatic detection of suitable breaks in the media stream. In this way, the media stream may be divided into segments or custom streams each separately accessible by the clients 7.1 . . . n.

In a further alternative, the EHLS 8 may define segments by means of boundary points relating to the media stream, and the clients 7.1 . . . n may request customised playlists 5.1 . . . n with reference to corresponding segments, as explained in more detail below.

Enhanced Live Media Streaming—Implementation

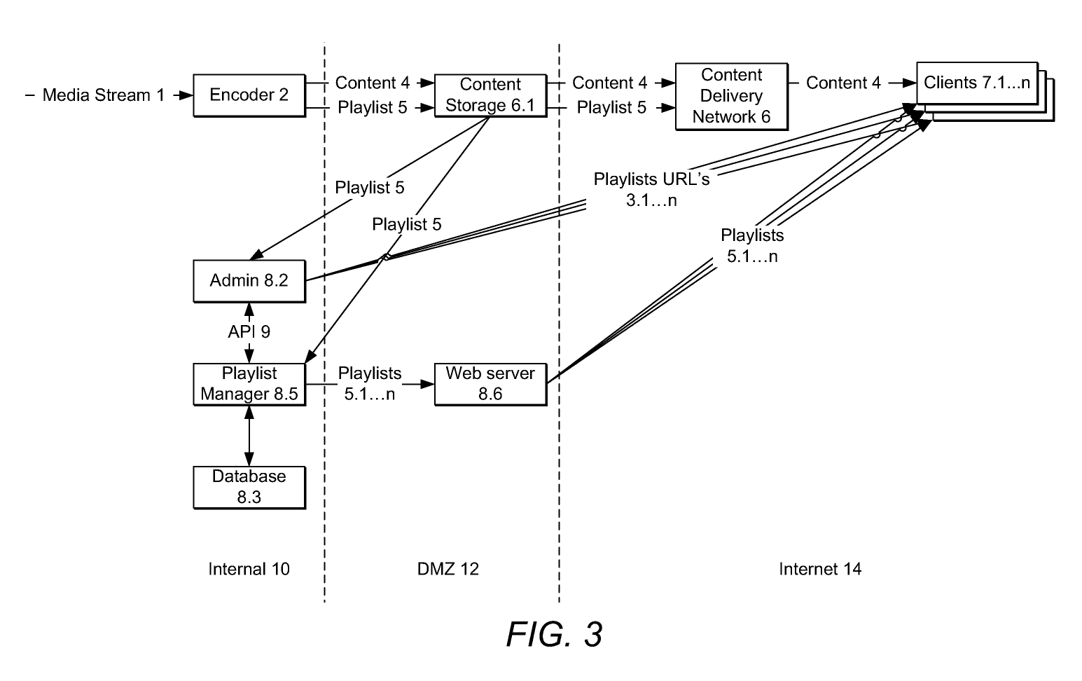

An example of a more detailed implementation of the embodiment of FIG. 2 is shown in FIG. 3, in which the functionality of the EHLS 8 is divided into three parts: web server 8.6 which services requests from clients 7.1 . . . 7n, admin 8.2 that allows definition of chapters and/or modified playlists, and playlist manager 8.5 which constructs, stores and presents playlists. Database 8.3, accessible to the playlist manager 8.5, records the addresses of each chunk of media content 4, as indicated by the periodically updated playlist 5. Playlist manager 8.5 creates the customized playlists from the database 8.3. The database schema also allows selection and labelling of segments.

An example of a schema for the database 8.3 is listed below, in which EVENTS defines the URI (Uniform Resource Identifier) and some details about the modified playlist, and CHUNK contains every piece of content referenced by an event:

```
CREATE TABLE ‘CHUNK‘ (
    ‘ID‘ varchar(150) NOT NULL DEFAULT ′′,
    ‘STREAM_ID‘ varchar(10) NOT NULL,
    ‘SEQ_NUM‘ int(50) unsigned DEFAULT NULL,
    ‘DURATION‘ int(50) unsigned DEFAULT NULL,
    ‘URI‘ varchar(255) DEFAULT NULL,
    ‘SECURE_KEY‘ varchar(255) DEFAULT NULL,
    ‘TIMESTAMP‘ datetime DEFAULT NULL,
    ‘BIT_RATE‘ varchar(10) NOT NULL,
    ‘STREAM_TYPE‘ varchar(150) NOT NULL DEFAULT′′
);
CREATE TABLE ‘EVENTS‘ (
    ‘ID‘ VARCHAR(255) NOT NULL,
    ‘CONTENT_EXPIRY‘ DATETIME DEFAULT NULL,
    ‘SOURCE_REF‘ VARCHAR(255) DEFAULT NULL,
    ‘DESCRIPTION‘ VARCHAR(255) DEFAULT NULL,
    ‘END_TIME‘ DATETIME DEFAULT NULL,
    ‘START_TIME‘ DATETIME DEFAULT NULL,
    ‘STREAM_ID‘ VARCHAR(255) DEFAULT NULL,
    ‘IS_FINISH‘ bit(1) DEFAULT b′0′ DEFAULT NULL,
);
```

Database 8.3 is preferably deployed into an internal network for security reasons.

Playlist manager 8.5 is an internal application, responsible for receiving instructions from the admin 8.2 and generating customised playlists 5.1 . . . n; it places the customised playlists on the web server 8.6

The web server 8.6 is in the DMZ (demilitarized zone) 12 or perimeter network between the internal network 10 and the Internet 14 and services requests from many clients 7.1 . . . n simultaneously and preferably caches responses.

Web server 8.6 is stateless such that it can be scaled out across several application servers without the need for complex synchronisation or load balancing persistence. Web server 8.1 may be implemented as a simple file server.
The API 9 accepts instructions from admin 8.2 to start, end, modify and delete playlists. The API is a REST service that fully complies with HTTP specs for use of GET, PUT, POST, DELETE. The API uses a JSON payload to serialize the request, which contains the relevant details for the action, and any response data. An example of the API used is shown in Appendix 1 below, where <id> identifies the media stream. An example of the JSON payload for the API is:

{″streamId″:″A″, ″description″:″desc″,″startTime″:″2011-01-
20T17:40:00″,” sourceReference”:”
sourceReference”,”endTime”:”2011-01-20T19:40:00”}

The client 7.1 . . . n polls the admin 8.2 at predefined intervals to retrieve the playlist URL's 3.1 . . . n as well as other data and metadata of available playlists. This allows the clients 7.1 . . . n to present an up-to-date list of available content to the user for selection.

An example of the URL which returns playlists 5.1 . . . n is given below, where <id> identifies the media stream:

URI: /insider/events/<id>
HTTP METHOD: GET

admin 8.2 is used for internal administration purposes only; it is preferably located within an internal network 10 not accessible from the Internet 14. admin 8.2 may comprise a user interface for editorial use, allowing users to define and annotate new segments, and manage existing segments.

Playlist manager 8.5 is also responsible for polling the stream URLs and populating the database 8.3 with the locations of newly available content chunks.

Playlist manager 8.5 may also initiate the clean-up of old or unreferenced content chunks from the content storage 6.1 or this can be done using scheduled scripts where content is to be kept for a pre-defined maximum period. In a conventional CDN 6, chunks will only be retained for a few minutes and are then deleted by the CDN 6, as only a live stream needs to be served. However, in the CDN 6 according to the present embodiment, chunks are preferably retained at least until their stream is closed, and preferably for a much longer period over which the streams are to be made available, after which the chunks should be deleted so as to maintain storage efficiency. The CDN 6 will perform its cleanup operations according to a predetermined configuration.

Playlist manager 8.5 may comprise a stream manager function, running as a background thread that checks for new media content 4 being added to the Content Storage 6.1. The polling threads periodically refresh the playlists 5.1 . . . n from the CDN 6, and update database 8.3 with any newly discovered chunks of media content 4.

In the embodiment described above, the media content chunk files are stored at the content storage 6.1 and CDN 6 with the following simple folder and file naming convention:

/[stream id]/[leg name]/[stream start time]/[chunk id].ts

The leg name allows support for a live and backup source to handle failover scenarios where a fault occurs in the encoder 2 or content storage 6.2. The web server 8.6 supports a similar failover scenario.

For example, the URL:

http://content.mobile-tv.sky.com/content/s2/live/20110215T113015-04-9/419.ts returns chunk serial number 419 from stream 2. The playlist manager 8.5 generates the customised playlists 5.1 . . . n by identifying which serial numbers correspond to the requested time or segment. All chunks will be of the same duration which may be, for example, 10 s or less.

Content Management System

In embodiments of the invention, there may be provided a content management system (CMS) application allowing CMS users (‘editors’) to create and manage media content to be made available to clients 7.1 . . . n. The CMS application may reside within the admin function 8.2, as described above. In particular, the media content may comprise one or more customised media streams based on live media streams, as described in the previous section.

The CMS application creates and manages metadata for each stream, including for example:
Name (user friendly name of original stream, for example Stream A)
URL to playlist of original live stream (for example http://content.mobile-tv.sky.com/content/sn/live/03.m3u8)
Start Date/Time (also known as an inpoint: an optional reference to the start time of the custom stream)
End Date/Time (also known as an outpoint: an optional reference to the end time of the custom stream)
Video type (custom live or custom clip, also known as ‘open’ or ‘closed’; a custom clip has an end point as well as a start point)
Event Type: breaking, normal or news alert
Slate Text (text to be displayed by the user interface if the customised media stream has not yet been defined, for example before the start date/time has been provided)
A set of annotations (additional information, such as a headline, referenced to a specified time within the customised stream).
The customised media stream and associated metadata is referred to below as a customised module.

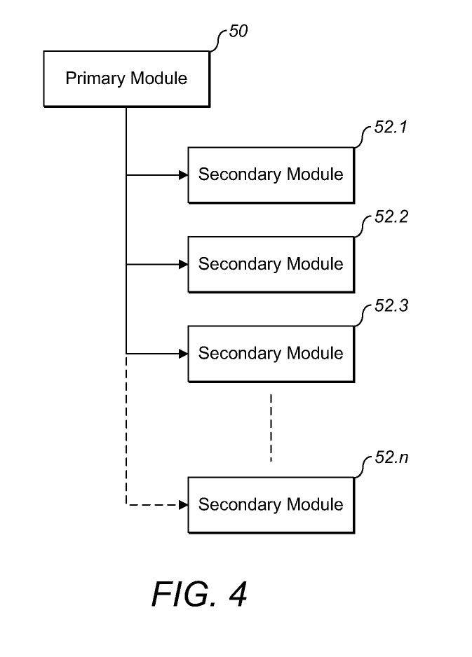

An example of use of the CMS application will now be described, in which an ‘event’ is created, comprising a primary module 50 and one or more associated secondary modules 52.1 . . . n, as illustrated in FIG. 4. The event may relate for example to a news item, the primary module 50 may comprise a news broadcast relating to the news item, and the secondary modules 52.1 . . . n may comprise additional content relating to the news item. Each event is preferably based on a single primary module 50 containing a video stream, although a still picture and/or audio only may be provided in the primary module 50 instead.

Each secondary module 52.1 . . . n preferably contains content of one type, such as:
a still image
an interactive image
an image gallery (multiple selectable images),
long text such as an article
short text such as a quote
a web page,
a video
a graphical object such as a graph
a feed, such as an RSS, Twitter or Facebook feed
   Some or all of the secondary modules may be encoded in a multimedia-enabled hypertext format, such as HTML5.

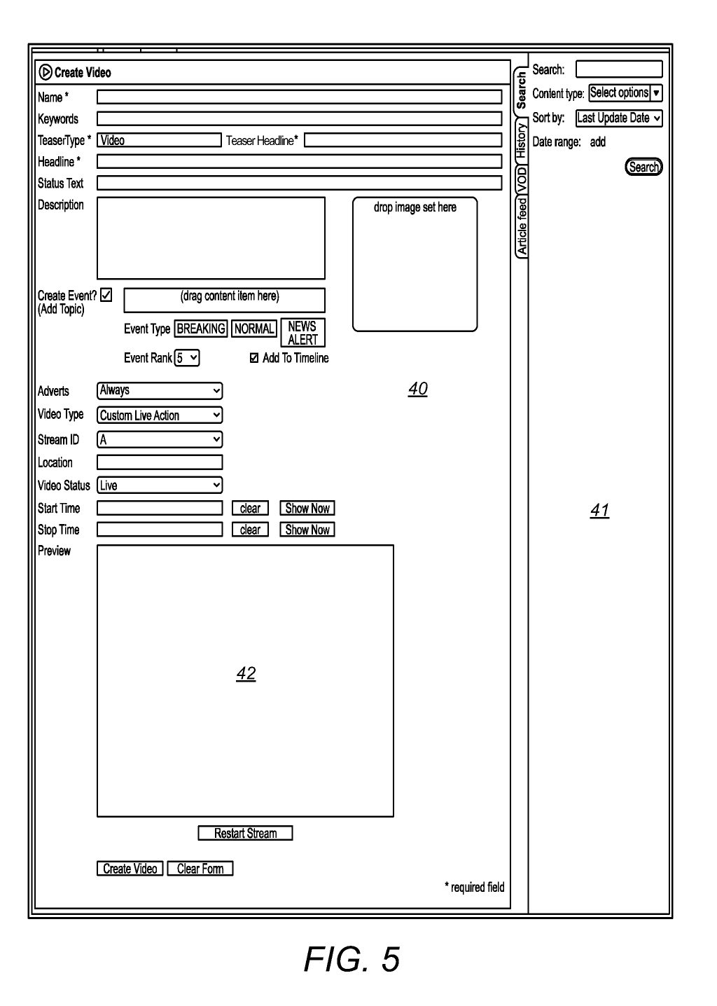

In a method of operation of the CMS application, the editor logs in to the CMS application and creates a customised module using a CMS editing screen as shown in FIG. 5, comprising a module selection pane 41 and a module editing pane 40. The module selection pane 41 allows the user to search for a module using one or more parameters, such as keywords and content type. The keywords may have been previously applied as metadata to the content to be searched. The search results may be displayed in the module selection pane 41 and one of the results may be selected to form the basis of a primary module.

In this example, the editor selects an available customised stream and enters the associated metadata in the module editing pane 40 to create a primary module. The editor may define the start and end points of the customised stream using this pane. The editor may select whether adverts (commercials) are to be inserted in the customised stream. The editor may preview the video content of the customised stream using a preview window 42.

The editor then creates an event comprising the primary module 50 and selects secondary modules 52.1 . . . 4 to attach to the primary module. The secondary events may be selected using the module selection pane 41 and added to the event, for example using a ‘drag and drop’ action.

The created event may be previewed in a test environment simulating one of the clients 7.1 . . . n. The event is then published on the CDN 6, for example by making available the customised media stream and content of the secondary modules, and providing the playlist of the customised media stream in the database 8.3.

The editor may change the media stream used for the custom stream module used as the primary module within the event, without changing other parameters of the event. The editor may modify the start time of the media stream, add an end time, or change the type of the stream. For example, an event may be created initially containing a live news broadcast about a particular news item as the customised stream. When the broadcast has finished discussing that news item, the customised module may be changed to a clip of the part of the news broadcast relating to that news item, by the editor manually setting the end time at which the discussion finished. The end time may be set in advance, if the expected end time of the discussion is known. The end time may be set automatically, for example based on data indicating the news broadcast schedule, or by automatic detection of a break point in the broadcast, such as a commercial break.

Client User Interface

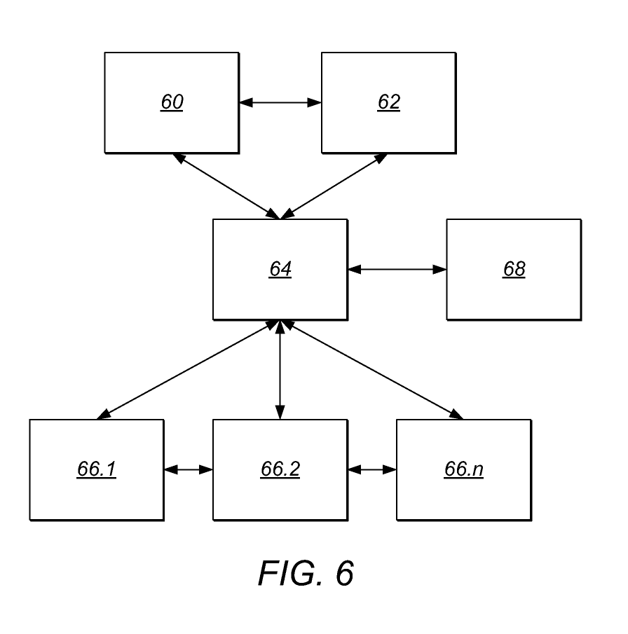

FIG. 6 is a schematic outline of a storyboard or screen flow diagram of a user interface of an interactive media application running on each of the clients 7.1 . . . n, and preferably incorporating the media player application as described above. The user interface is preferably defined by program code within the interactive media application, although some of the individual functions of the user interface may be performed by operating system calls. The interactive media application may comprise a computer program that is loaded onto the client device.

In this specific embodiment, each client has a touch-sensitive screen for presenting interactive content, and user selection may comprise a touch or gesture from the user on the screen. The clients 7.1 . . . n may for example be iPad® devices running iOS 4.2, both from Apple, Inc, and the interactive media application may comprise an ‘app’ downloadable onto the client device wirelessly, or via a wired connection to a computer. However, aspects of the present invention are not limited to Apple® devices and/or operating systems. For example, conventional HLS is supported by the Android® operating system and by Microsoft® IIS Media Services, and enhanced HLS services according to embodiments of the invention may also be applied to these and other operating systems and services.

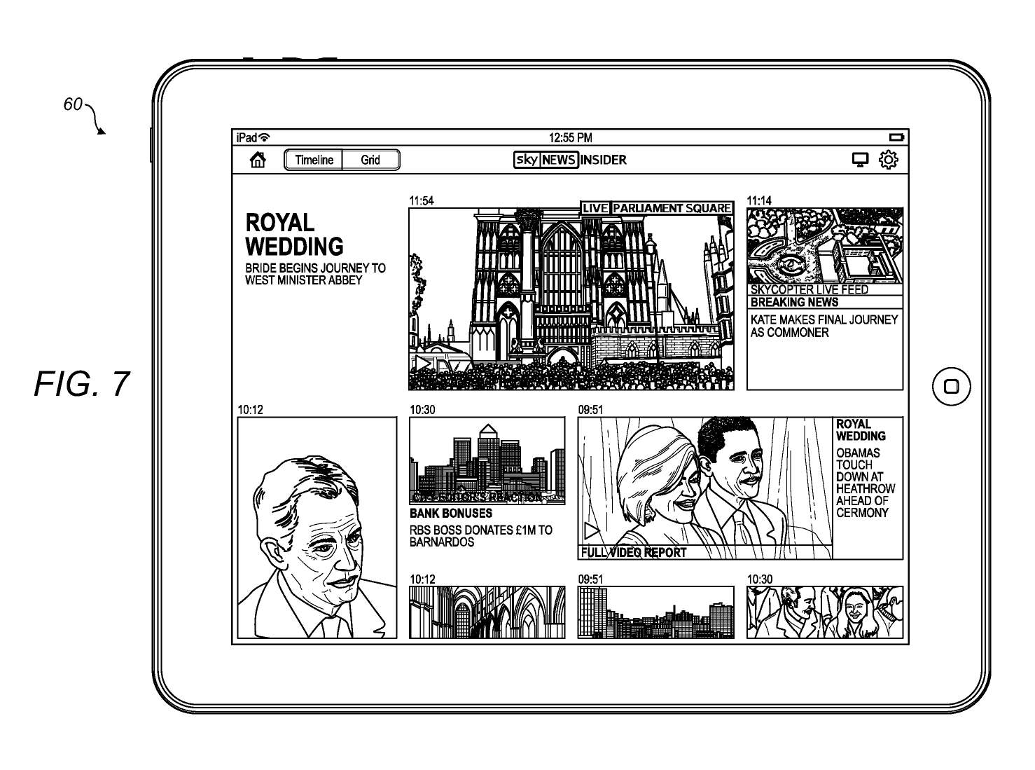

In this specific embodiment, the user interface presents a series of events each relating to a news item, as described above. Sample screenshots are shown in FIGS. 7 to 10 illustrating mocked-up events.

A top level or grid screen 60 displays a selected one or more of the available events, a welcome screen and/or other information. In the example shown in FIG. 7, the displayed events include a main event relating to a royal wedding, in the upper part of the screen, and a selection of events in the lower part of the screen, tagged by time but not arranged in chronological order. The main event includes one or more live video streams (‘Live Parliament Square’ and ‘Skycopter Live Feed’); depending on the limitations of the client 7.1 . . . n, only one live video stream may be selectable for display at any one time.

The user navigates between the top level screen 60 and a timeline screen 62, for example by toggling ‘timeline’ and ‘grid’ buttons as shown towards the top left of the screen

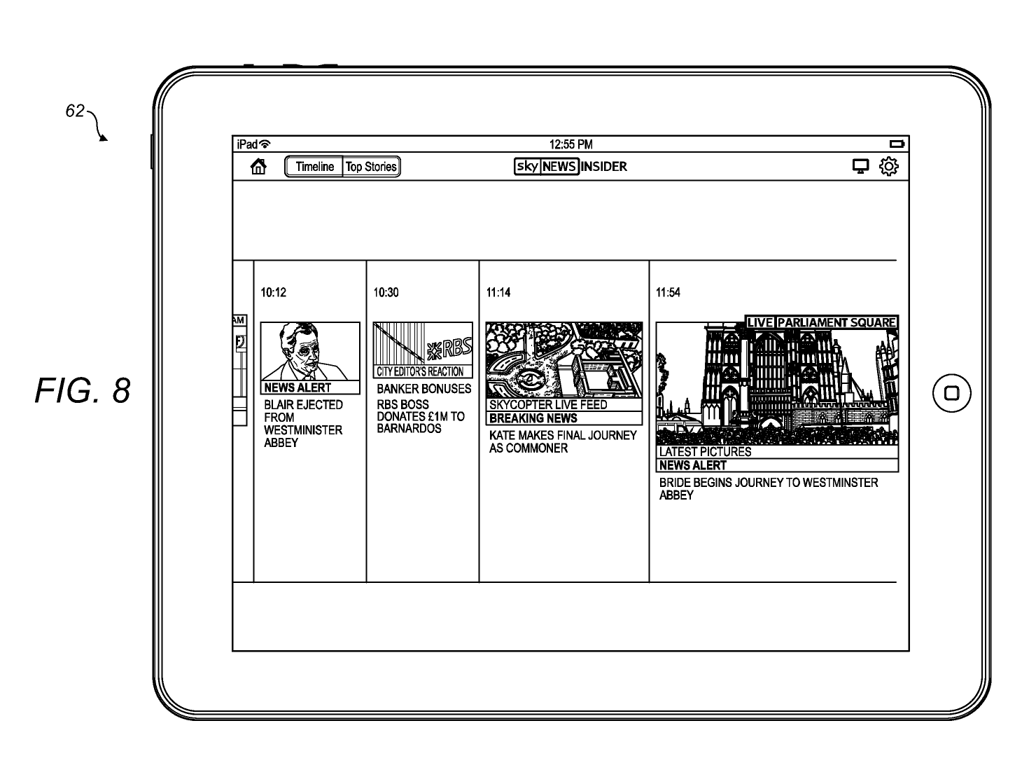

As shown for example in FIG. 8, the timeline screen 62 displays a series of events in a timeline, ordered according to a respective date and time associated with each event, which may be the start date/time of the custom stream module as described above, or another manually or automatically set date and time, such as the date and time of publication of the event. Each event is represented by a still or video image derived from the associated custom media stream, preferably with a display of the associated date/time. The user may zoom in to a selected event on the timeline, for example by touching that event (in this case, the event containing the ‘Live Parliament Square’ live video stream).

An example of the response received by the interactive media application and used to generate the timeline screen 62 is given in Appendix 2 below.

From either the grid screen 60 or timeline screen 62, the user may select an event and navigate to an event home screen 64 for that event. The interactive media application may request the URL corresponding to the selected event, for example as listed in the timeline response above. The response comprises the event including its primary module and associated secondary modules. An example event response is given in Appendix 3 below, in which an event about “Cameron's Big Society” contains a custom live clip as the primary module 50 and a quote module, a table module and an article module as secondary modules 52.1 . . . 3.

In the event home screen 64, the primary module is displayed together with at least some content relating from the associated secondary modules. In this case, the primary module is represented in a central or primary position, and the secondary modules are arranged in a peripheral, subordinate or secondary position, such as around the primary modules. In this way, the relationship between the primary and secondary modules is represented to the user, for example by means of a ‘hub and spoke’ visual metaphor.

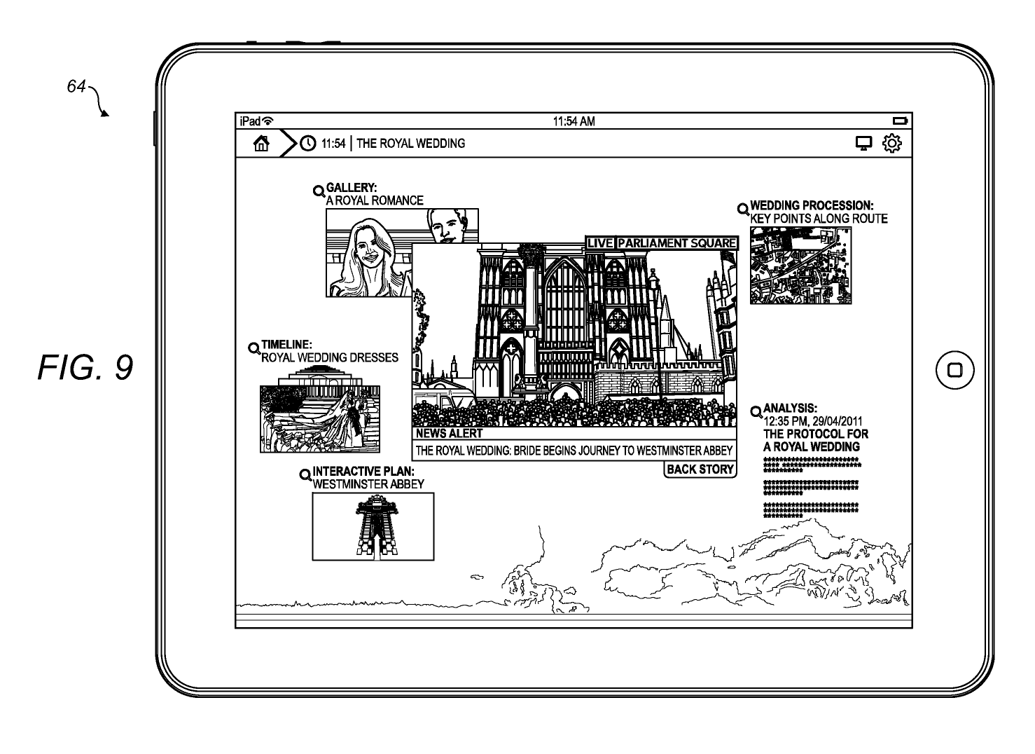

As shown in FIG. 9, for example, the primary module comprises the live video stream ‘Live Parliament Square’, while the secondary modules are shown as ‘Gallery: a royal romance’ (image gallery), ‘Wedding procession: key points along route’ (interactive image), ‘Analysis’ (long text), ‘Interactive plan: Westminster Abbey’ (interactive image), ‘Timeline: royal wedding dresses’ (gallery/timeline).

The customised media stream of the primary module may be played on the event home screen 64. Alternatively or additionally, the user may navigate between the event home screen 64 and a full screen display of the customised media stream of the primary module, in which the secondary modules are not displayed.

Only a subset of the content of the secondary modules is displayed on the event home screen 64. The subset may comprise for example: one image from a gallery, a still from an interactive image, or part of a long text. This subset acts as a ‘teaser’ or invitation for the user to select a secondary module and display more of the content thereof.

The user may select any one of the secondary modules to navigate to a corresponding single module screen 66.1 . . . n for displaying the content of the secondary module. The user may navigate directly between single module screens relating to different secondary modules. Some or all of the single module screens may also include a display of the primary module in a secondary or peripheral position, such as a corner of the screen. The user may navigate to the event home screen 64 by selecting the display of the primary module.

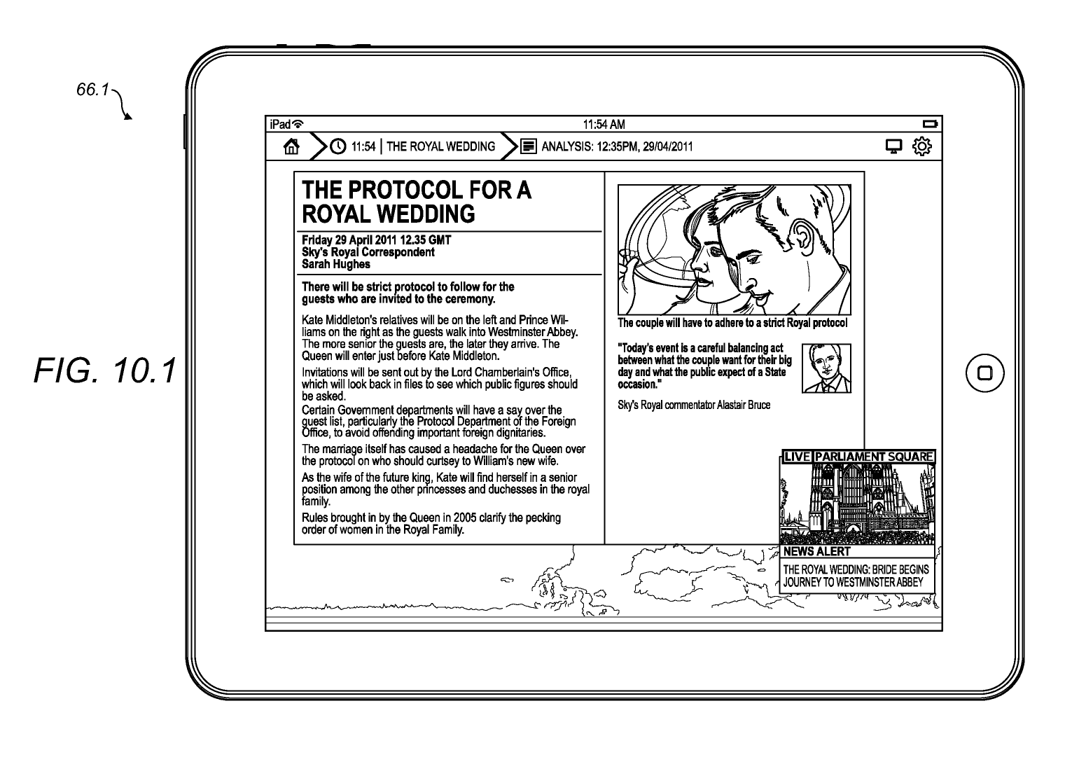

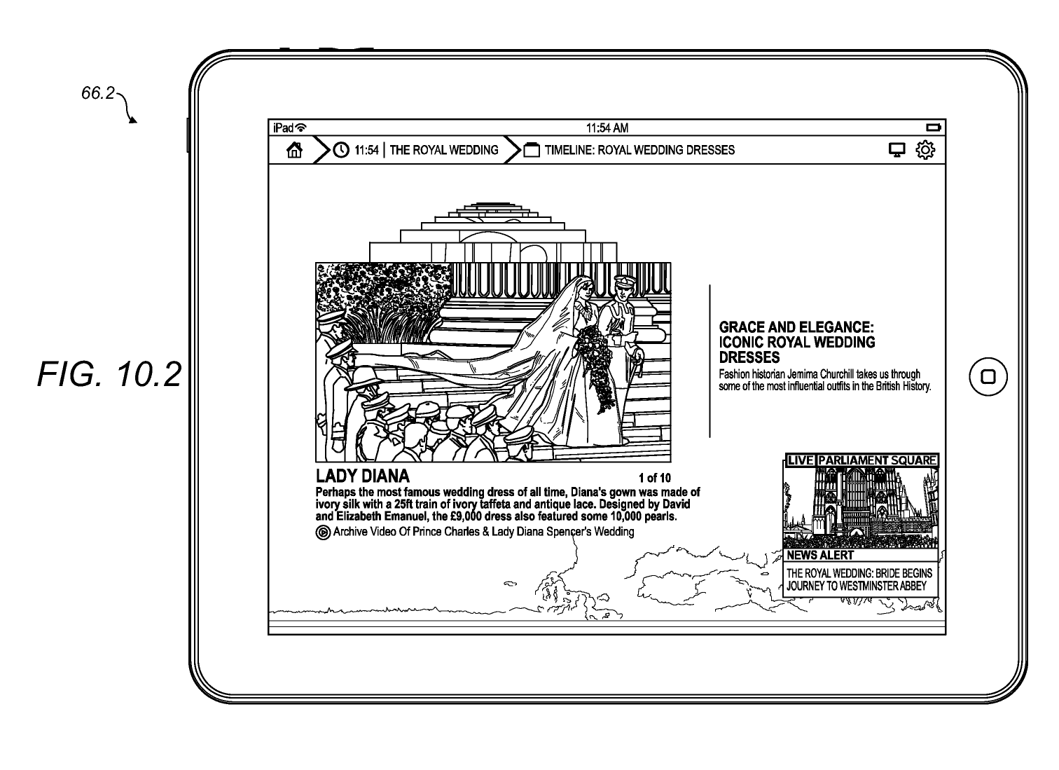

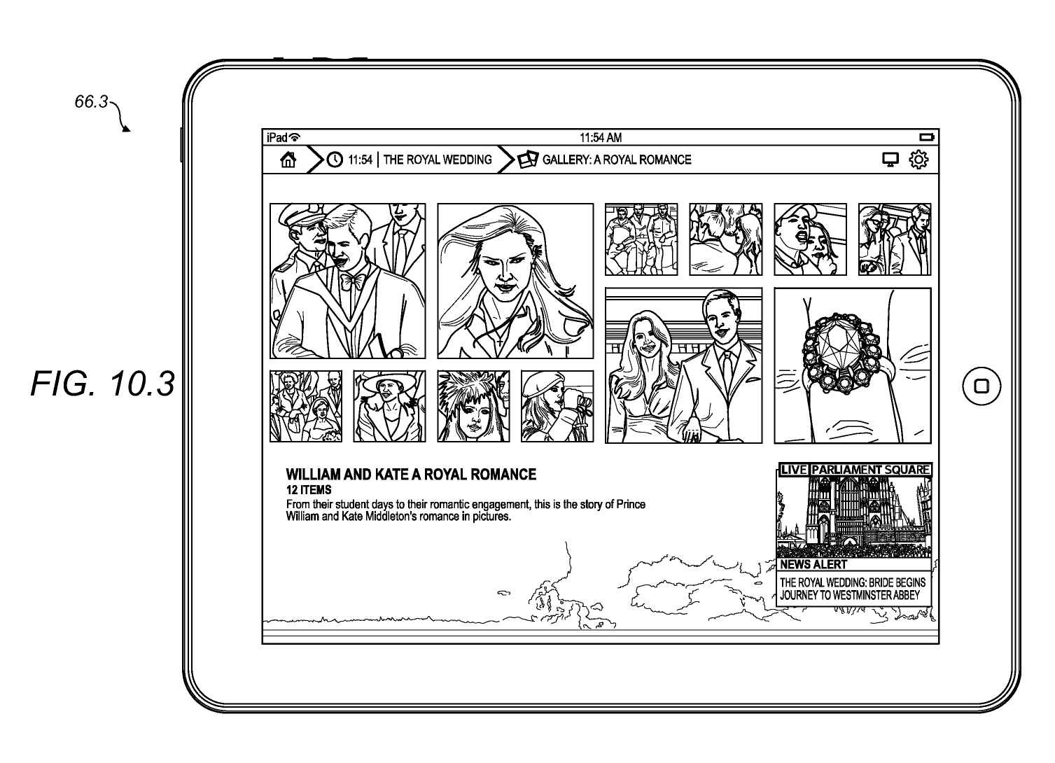

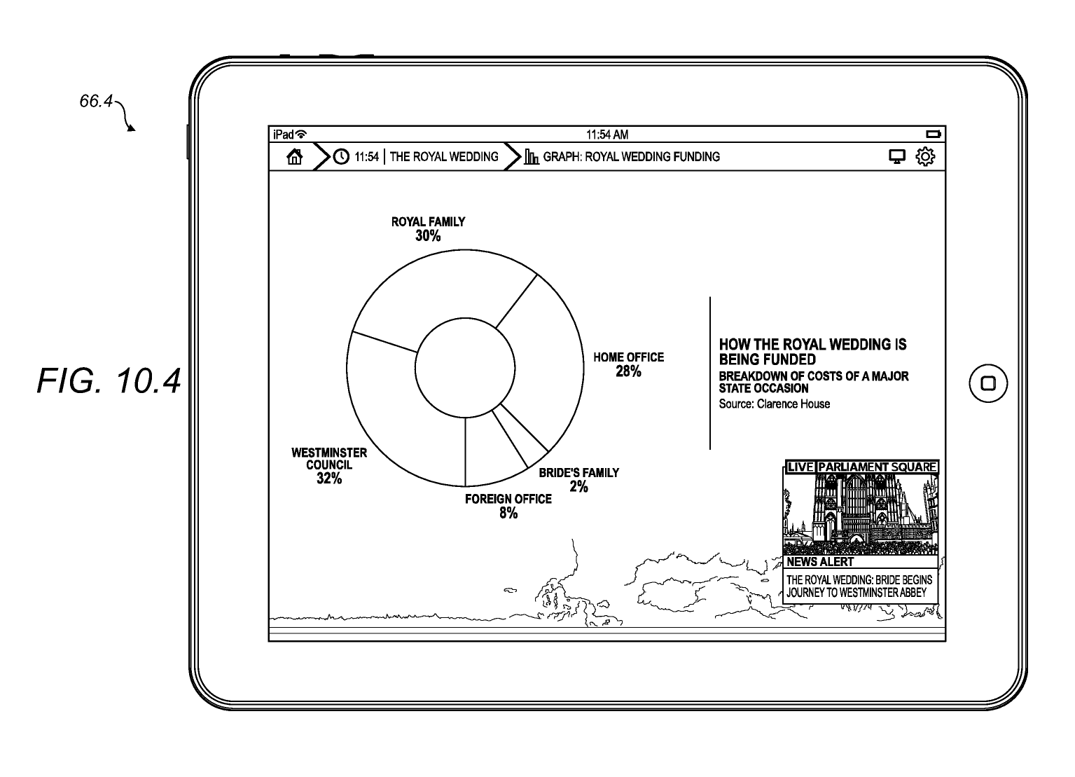

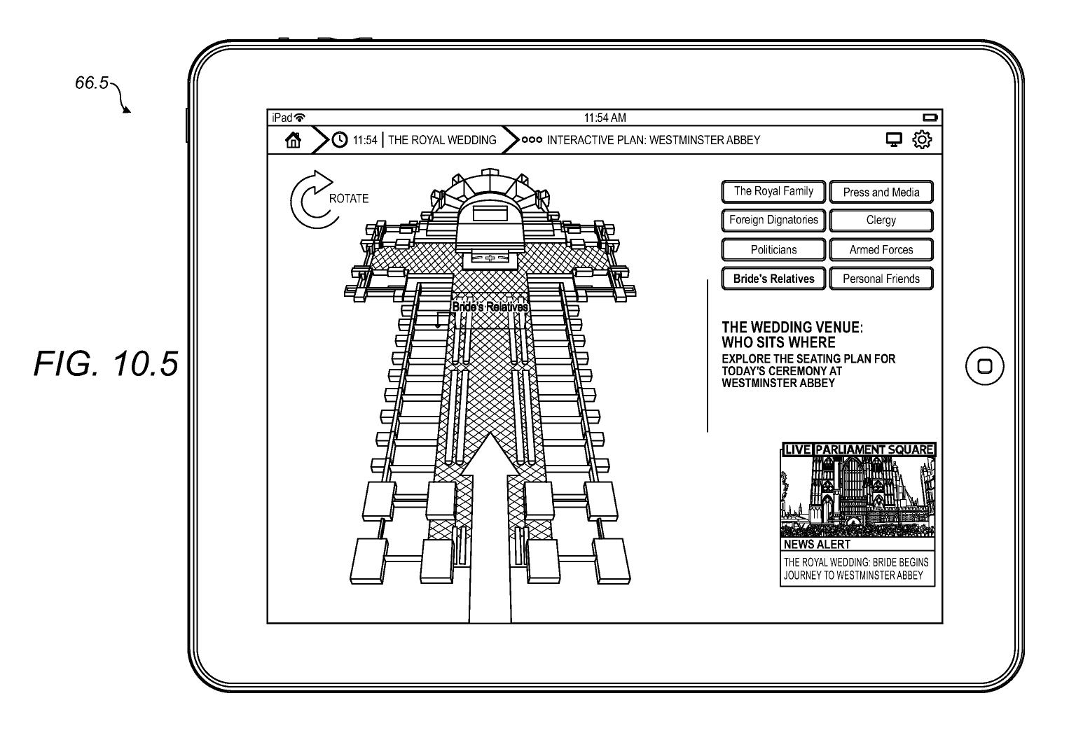

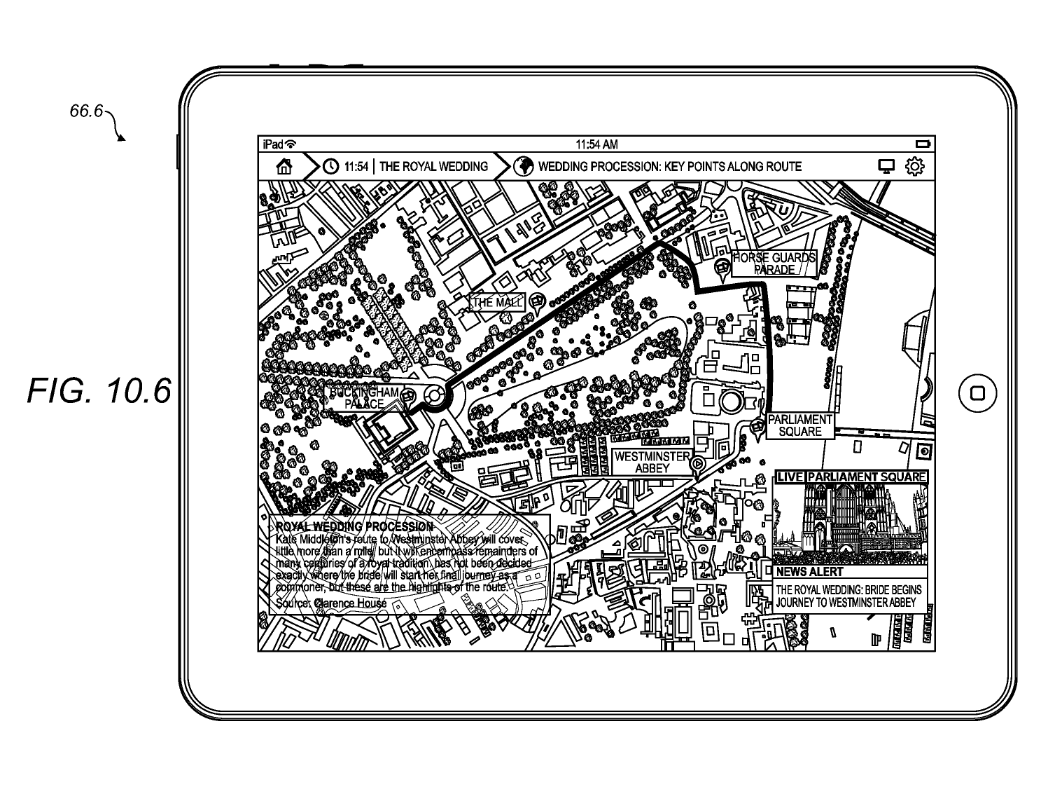

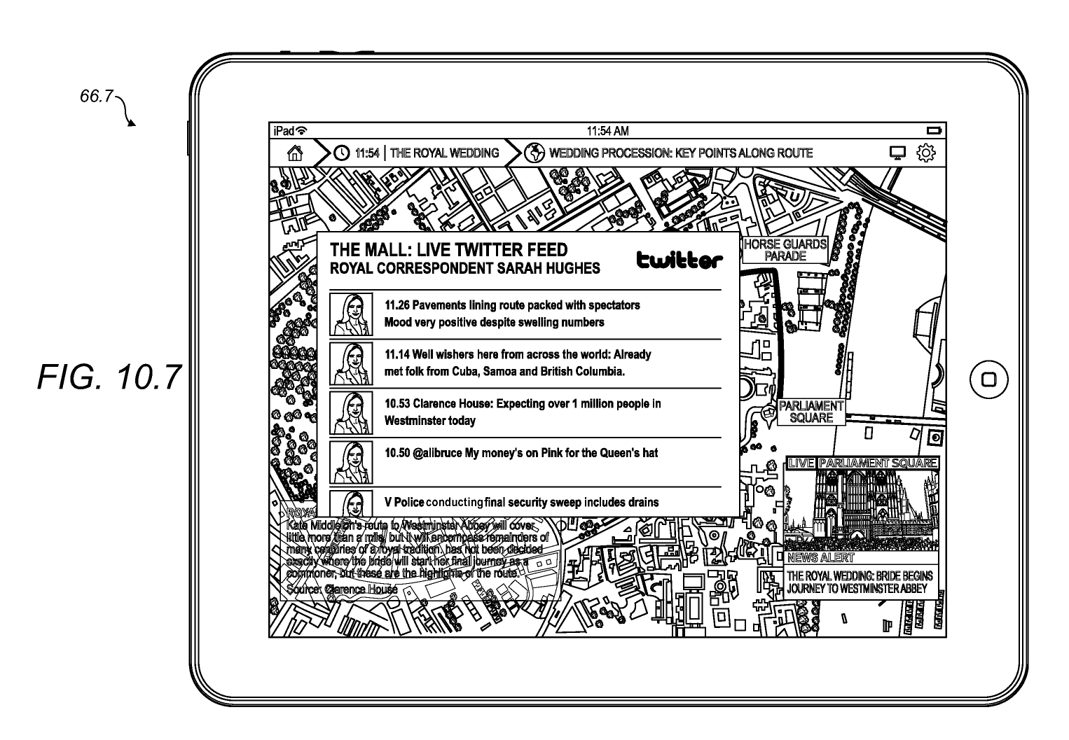

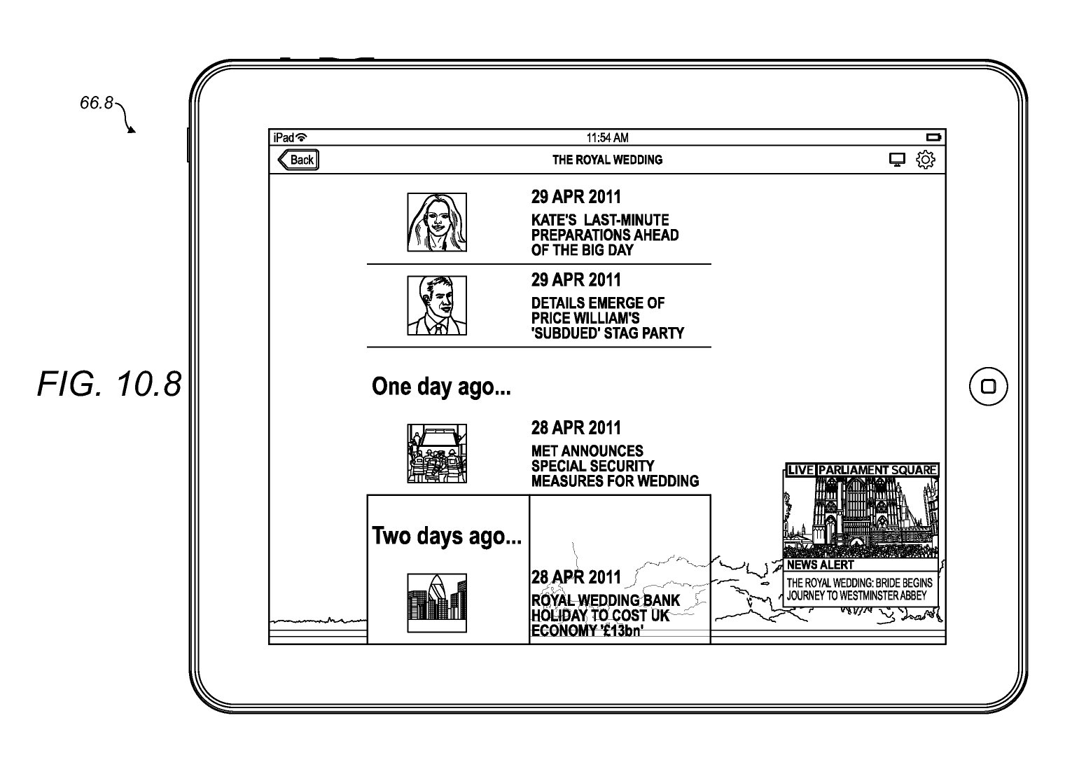

By way of example, FIGS. 10.1 to 10.6 show examples of single module screens relating respectively to: an article, a feature, a gallery, an HTML5 object and a map, all relating to the same event, in this case the royal wedding.

Additionally, a feed such as a news or social feed may be associated with a secondary module, or the feed may itself comprise the secondary module. For example, FIG. 10.7 shows a Twitter® feed associated with the map of FIG. 10.6.

Secondary modules may be shared with other users, including for example users to whom the event-based user interface is not available. For example, a user may send a secondary module to a friend as an email attachment, link to it in a tweet, and/or post it on Facebook®. An HTML5 encoded secondary module is particularly suitable for this type of sharing, as it can be displayed in any HTML5 compatible browser.

The user may navigate between the event home screen 64 and a ‘backstory’ screen 68 comprising one or more displays relating to previous events linked to the event displayed in the event home screen 64. The linking of events may be by means of shared metatags, such as ‘royal wedding’. For example, as shown FIG. 10.8, the backstory screen 68 comprises a vertical timeline arranged by day, each display comprising a still and a headline from the associated event.

Computer Systems

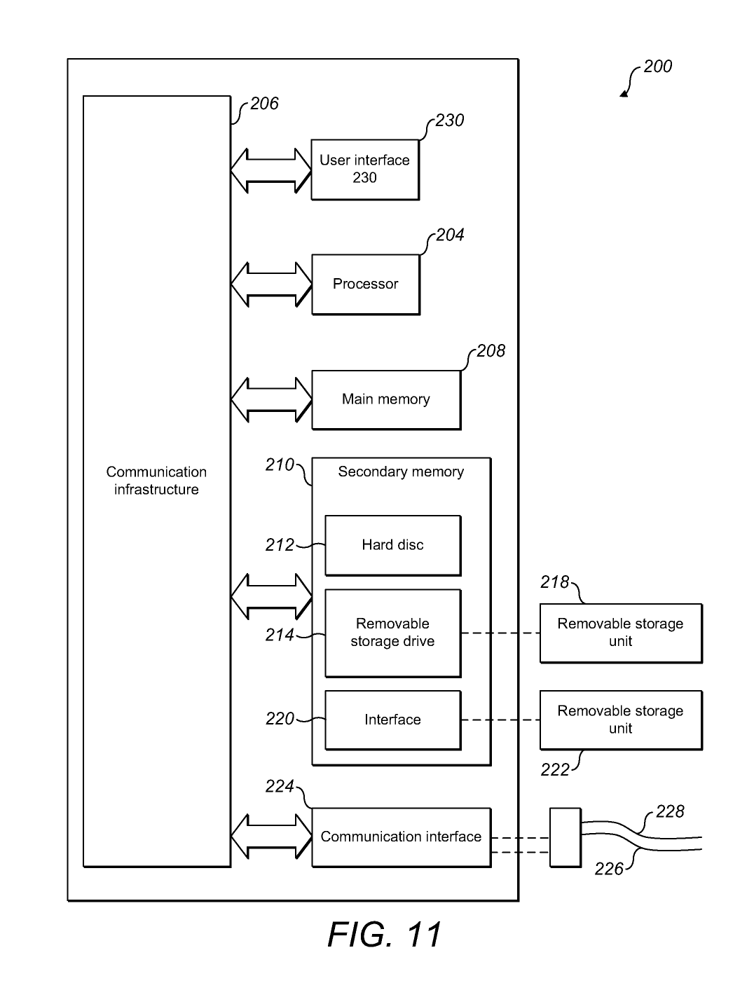

The entities described herein, such as those shown in FIGS. 2 and/or 3, may be implemented by computer systems such as computer system 200 as shown in FIG. 11. Embodiments of the present invention may be implemented as programmable code for execution by such computer systems 200. After reading this description, it will become apparent to a person skilled in the art how to implement the invention using other computer systems and/or computer architectures.

Computer system 200 includes one or more processors, such as processor 204. Processor 204 may be any type of processor, including but not limited to a special purpose or a general-purpose digital signal processor. Processor 204 is connected to a communication infrastructure 206 (for example, a bus or network). Various software implementations are described in terms of this exemplary computer system. After reading this description, it will become apparent to a person skilled in the art how to implement the invention using other computer systems and/or computer architectures.

Computer system 200 also includes a main memory 208, preferably random access memory (RAM), and may also include a secondary memory 610. Secondary memory 210 may include, for example, a hard disk drive 212 and/or a removable storage drive 214, representing a floppy disk drive, a magnetic tape drive, an optical disk drive, etc. Removable storage drive 214 reads from and/or writes to a removable storage unit 218 in a well-known manner. Removable storage unit 218 represents a floppy disk, magnetic tape, optical disk, etc., which is read by and written to by removable storage drive 214. As will be appreciated, removable storage unit 618 includes a computer usable storage medium having stored therein computer software and/or data.

In alternative implementations, secondary memory 210 may include other similar means for allowing computer programs or other instructions to be loaded into computer system 200. Such means may include, for example, a removable storage unit 222 and an interface 220. Examples of such means may include a program cartridge and cartridge interface (such as that previously found in video game devices), a removable memory chip (such as an EPROM, or PROM, or flash memory) and associated socket, and other removable storage units 222 and interfaces 220 which allow software and data to be transferred from removable storage unit 222 to computer system 200. Alternatively, the program may be executed and/or the data accessed from the removable storage unit 222, using the processor 204 of the computer system 200.

Computer system 200 may also include a communication interface 224. Communication interface 224 allows software and data to be transferred between computer system 200 and external devices. Examples of communication interface 224 may include a modem, a network interface (such as an Ethernet card), a communication port, a Personal Computer Memory Card International Association (PCMCIA) slot and card, etc. Software and data transferred via communication interface 224 are in the form of signals 228, which may be electronic, electromagnetic, optical, or other signals capable of being received by communication interface 224. These signals 228 are provided to communication interface 224 via a communication path 226. Communication path 226 carries signals 228 and may be implemented using wire or cable, fibre optics, a phone line, a wireless link, a cellular phone link, a radio frequency link, or any other suitable communication channel. For instance, communication path 226 may be implemented using a combination of channels.

Computer system 200 may also include a user interface 230, either locally or remotely connected to the communication infrastructure 206. Examples of the user interface 206 may include one or more of a display screen, a touch screen, a projector, a haptic interface, a keyboard, a mouse, a touch pad, a voice recognition interface, a voice synthesiser, a gesture interface, and a motion tracking interface.

A computer system 200 for use as a client 7.1 . . . n is preferably a portable device with wireless Internet connectivity.

The terms “computer program medium” and “computer usable medium” are used generally to refer to media such as removable storage drive 214, a hard disk installed in hard disk drive 212, and signals 228. These computer program products are means for providing software to computer system 200. However, these terms may also include signals (such as electrical, optical or electromagnetic signals) that embody the computer program disclosed herein.

Computer programs (also called computer control logic) are stored in main memory 208 and/or secondary memory 210. Computer programs may also be received via communication interface 224. Such computer programs, when executed, enable computer system 200 to implement embodiments of the present invention as discussed herein. Accordingly, such computer programs represent controllers of computer system 200. Where the embodiment is implemented using software, the software may be stored in a computer program product and loaded into computer system 200 using removable storage drive 214, hard disk drive 212, or communication interface 224, to provide some examples.

Alternative embodiments may be implemented as control logic in hardware, firmware, or software or any combination thereof.

### ALTERNATIVE EMBODIMENTS

Alternative embodiments may be envisaged on reading the present application, which nevertheless fall within the scope of the following claims.

### APPENDIX 1

### Example of API 9

| | HTTP | | | Response | |
|---|---|---|---|---|---|
| URI Template | Method | Description | Status | Content | Response Contains |
| /events/<id> | GET | Gets an Event resource | 200 | OK | Serialized resource (Event |
| | | by id | | | representation in JSON) |
| | | | 304 | Not Modified | Empty (If-None-Match supported |
| | | | | | for Etag) |
| | | | 400 | Bad Request | Empty or Serialized error message |
| | | | 404 | Not Found | Empty |
| /events | GET | Gets a list of Events | 200 | OK | Serialized list of event ids, (or could |
| | | | | | be serialized list of Event objects in |
| | | | | | JSON) |
| | | | 400 | Bad Request | Empty or Serialized error message |
| /events | POST | Adds an Event resource | 200 | OK | Serialized resource |
| | | | 204 | No Content | Empty |
| | | | 400 | Bad Request | Empty or Serialized error message |
| | | | 409 | Conflict | Empty or Serialized error message |
| /events/<id> | PUT | Adds or Updates an | 200 | OK | Updated resource |
| | | existing resource | 204 | No Content | Empty |
| | | identified by URI. | 400 | Bad Request | Empty or Serialized error message |
| | | Service will allow add | 404 | Not Found | Empty or Serialized error message |
| | | with PUT. Updated | 409 | Conflict | Empty or Serialized error message |
| | | resource can be | | | |
| | | returned with a 200. Or | | | |
| | | no resource can be | | | |
| | | returned with a 204. | | | |
| /events/<id> | DELETE | Removes the resource | 200 | OK | Deleted Resource |
| | | identified by URI. | 204 | No Content | Empty |
| | | Removed resource can | 400 | Bad Request | Empty or Serialized error message |
| | | be returned with a 200. | 404 | Not Found | Empty or Serialized error message |
| | | Or no resource can be | 409 | Conflict | Empty or Serialized error message |
| | | returned with a 204. | | | |
| /events/<id>.m3u8 | GET | Returns the appropriate | 200 | OK | Serialized resource (m3u8) |
| | | Master playlist for the | 304 | Not Modified | Empty (If-None-Match supported |
| | | given Event id | | | for Etag) |
| | | | 400 | Bad Request | Empty or Serialized error message |
| | | | 404 | Not Found | Empty |

### APPENDIX 2

### Example of Timeline Response

```
{“topics”:
[
      {“id”:“urn:skynews:topic:2849”,“revision”:12976877
59,“self”:“http://online.stage.icms.news.sky.com/icms/rest/insider
/topic/2849.json”,“type”:“topic”,“date”:1297686581,“name
”:“London Stabbings
”,“description”:null,“imageTag”:“topic”},
      {“id”:“urn:skynews:topic:748”,“revision”:129742588
6,“self”:“http://online.stage.icms.news.sky.com/icms/rest/insider
/topic/748.json”,“type”:“topic”,“date”:1297420065,“name
”:“Olympic Stadium”,“description”:null,“imageTag”:“topic”},
      {“id”:“urn:skynews:topic:2437”,“revision”:12973425
84,“self”:“http://online.stage.icms.news.sky.com/icms/rest/insider
/topic/2437.json”,“type”:“topic”,“date”:1297337591,“name
”:“Gorbachev
Speaks”,“description”:null,“imageTag”:“topic”},
      {“id”:“urn:skynews:topic:1478”,“revision”:12977016
31,“self”:“http://online.stage.icms.news.sky.com/icms/rest/insider
/topic/1478.json”,“type”:“topic”,“date”:1297696853,“name
”:“Child Fire
Deaths”,“description”:null,“imageTag”:“topic”}
],“events”:
[
{
      “id”:“urn:skynews:event:2972”,
      “revision”:1297703266,
      “self”:“http://online.stage.icms.news.sky.com/icms
/rest/insider/event/2972.json”,
      “type”:“event”,
      “date”:1297702920,
      “teaserHeadline”:
      “Cameron's Big Society”,
      “teaserType”:“”,
      “importance”:0,
      “rank”:1,
      “headline”:“Cameron Insists He Will Not Back Down
Over Flagship Policy”,
      “statusText”:“POLITICAL EDITOR'S ANALYSIS”,
      “newsType”:“normal”,
      “templateId”:“NEED TO BE IMPLEMENTED”,
      “topicId”:“urn:skynews:topic:2700”,
      “video”:
      {
          “id”:“urn:skynews:video:2971”,
          “revision”:1297703266,
          “status”:“LIVE”,
          “location”:“”,
      “self”:“http://online.stage.icms.news.sky.com/icms
/rest/insider/video/2971.json”,
          “type”:“video”,
          “date”:1297704049,
          “teaserPhoto”:
          {
              “id”:“urn:skynews:photo:2797”,
              “revision”:1297680262,
      “self”:“http://online.stage.icms.news.sky.com/icms
/rest/insider/imageset/2797.json”,
              “type”:“photo”,
              “date”:1297678399,
      “imageUrl”:“http://online.stage.icms.news.sky.com/
icms/images/2011/02/14/2797/{tag}/{width}/{height}/129767839
9-jpg”,
              “source”:“Getty”
          },
          “videoType”:“PLAYLIST”,
      “url”:“http://10.20.148.11:8080/insider/events/E65
9E9F8-A730-045D-FEA7-97DC16EB6AC0.m3u8”
      },
      “photo”:
      {
          “id”:“urn:skynews:photo:2797”,
          “revision”:1297680262,
      “self”:“http://online.stage.icms.news.sky.com/icms
/rest/insider/imageset/2797.json”,
          “type”:“photo”,
          “date”:1297678399,
      “imageUrl”:“http://online.stage.icms.news.sky.com/
icms/images/2011/02/14/2797/{tag}/{width}/{height}/129767839
9-jpg”,
          “source”:“Getty”
      }
}
]
{
```

### APPENDIX 3

### Example of Event Response

```
{
“event”:
      {
      “id”:“urn:skynews:event:2972”,
      “revision”:1297703266,
      “self”:“http://online.stage.icms.news.sky.com/icms
/rest/insider/event/2972.json”,
      “type”:“event”,
      “teaserHeadline”:“Cameron's Big Society”,
      “teaserType”:“ ”,“
      headline”:“Cameron Insists He Will Not Back Down
Over Flagship Policy”,
      “date”:1297702920,
      “statusText”:“POLITICAL EDITOR'S ANALYSIS”,
      “newsType”:“normal”,
      “templateId”:“NEED TO BE IMPLEMENTED”,
      “topicId”:“urn:skynews:topic:2700”,
      “video”:
          {
          “id”:“urn:skynews:video:2971”,
          “revision”:1297703266,
          “status”:“LIVE”,
          “location”:“ ”,
      “self”:“http://online.stage.icms.news.sky.com/icms
/rest/insider/video/2971.json”,
          “type”:“video”,
          “date”:1297704049,
          “teaserPhoto”:
              {
              “id”:“urn:skynews:photo:2797”,
              “revision”:1297680262,
      “self”:“http://online.stage.icms.news.sky.com/icms
/rest/insider/imageset/2797.json”,
              “type”:“photo”,
              “date”:1297678399,
      “imageUrl”:“http://online.stage.icms.news.sky.com/
icms/images/2011/02/14/2797/{tag}/{width}/{height}/129767839
9.jpg”,
              “source”:“Getty”
              },
          “videoType”:“PLAYLIST”,
      “url”:“http://10.20.148.11:8080/insider/events/E65
9E9F8-A730-045D-FEA7-97DC16EB6AC0.m3u8”
          },
      “topic”:
          {
          “id”:“urn:skynews:topic:2700”,
          “revision”:1297674820,
      “self”:“http://online.stage.icms.news.sky.com/icms
/rest/insider/topic/2700.json”,
          “type”:“topic”,
          “date”:1297664155,
          “name”:“Big Society”,
          “description”:null,
          “imageTag”:“topic”,
          “photo”:
              {
              “id”:“urn:skynews:photo:835”,
              “revision”:1296750552,
      “self”:“http://online.stage.icms.news.sky.com/icms
/rest/insider/imageset/835.json”,
              “type”:“photo”,
              “date”:1296737091,
      “imageUrl”:“http://online.stage.icms.news.sky.com/
icms/images/2011/01/21/835/{tag}/{width}/{height}/1296737091
.jpg”,
              “source”:“ ”
              }
          },
      “photo”:
          {
          “id”:“urn:skynews:photo:2797”,
          “revision”:1297680262,
      “self”:“http://online.stage.icms.news.sky.com/icms
/rest/insider/imageset/2797.json”,
          “type”:“photo”,
          “date”:1297678399,
      “imageUrl”:“http://online.stage.icms.news.sky.com/
icms/images/2011/02/14/2797/{tag}/{width}/{height}/129767839
9.jpg”,
          “source”:“Getty”
          },
      “modules”:
      [
          {
          “id”:“urn:skynews:quote:2844”,
          “revision”:1297687759,
      “self”:“http://online.stage.icms.news.sky.com/icms
/rest/insider/quote/2844.json”,
          “type”:“quote”,
          “date”:1297685765,
          “teaserHeadline”:“Big Society Bank”,
          “teaserType”:“Quote”,
          “teaserText”:“\”...the intention is for the
bank to be as independent and unbureaucratic as
possible...\“ ”,
          “teaserPhoto”:
              {
              “id”:“urn:skynews:photo:2774”,
              “revision”:1297674820,
      “self”:“http://online.stage.icms.news.sky.com/icms
/rest/insider/imageset/2774.json”,
              “type”:“photo”,
              “date”:1297673759,
      “imageUrl”:“http://online.stage.icms.news.sky.com/
icms/images/2011/02/14/2774/{tag}/{width}/{height}/129767375
9.jpg”,
              “source”:“ ”
              },
          “position”:1
          },
          {
          “id”:“urn:skynews:table:2795”,
          “revision”:1297693240,
      “self”:“http://online.stage.icms.news.sky.com/icms
/rest/insider/table/2795.json”,
          “type”:“table”,
          “date”:1297693233,
          “teaserHeadline”:“Ideologies Of British Prime
Ministers ”,
          “teaserType”:“Table”,
          “teaserText”:“Thatcherism|Post-
Thatcherism|New Labour|Brownites|Big Society”,
          “headline”:“The Ideas The Drive Our Leaders”,
          “teaserPhoto”:
              {
              “id”:“urn:skynews:photo:1589”,
              “revision”:1296750552,
      “self”:“http://online.stage.icms.news.sky.com/icms
/rest/insider/imageset/1589.json”,
              “type”:“photo”,
              “date”:1296655325,
      “imageUrl”:“http://online.stage.icms.news.sky.com/
icms/images/2011/02/02/1589/{tag}/{width}/{height}/129665532
5.jpg”,
              “source”:“ ”
              },
          “position”:2
          },
          {
          “id”:“urn:skynews:article:2701”,
          “revision”:1297674820,
      “self”:“http://online.stage.icms.news.sky.com/icms
/rest/insider/article/2701.json”,
          “type”:“article”,
          “date”:1297664133,
          “teaserHeadline”:“Cameron's 'Mission' In
Politics”,
          “teaserType”:“Article”,
          “teaserText”:“PM To Make Speech To
Entrepreneurs”,
          “teaserPhoto”:
              {
              “id”:“urn:skynews:photo:2316”,
              “revision”:1297263202,
      “self”:“http://online.stage.icms.news.sky.com/icms
/rest/insider/imageset/2316.json”,
              “type”:“photo”,
              “date”:1297251278,
      “imageUrl”:“http://online.stage.icms.news.sky.com/
icms/images/2011/02/09/2316/{tag}/{width}/{height}/129725127
8.jpg”,
              “source”:“ ”
              },
          “position”:3
      ]
      }
}
```

1. A method of providing streaming media over a network, in which a media stream is stored on a server as a plurality of discrete media files, and a playlist is provided indicating which media files are required for output of a specific part of the media stream; the method comprising:
receiving requests relating to corresponding different parts of the media stream;
providing a plurality of mutually different playlists for the media stream to respective different media streaming clients, in response to the requests relating to corresponding different parts of the media stream.

2. The method of claim 1, wherein at least one of the requests relates to a time point within the media stream.

3. The method of claim 1, wherein at least one of the requests relates to a predefined segment within the media stream.

4. The method of claim 1, wherein at least one the requests comprises a search request.

5. The method of claim 1, wherein the media stream is a live media stream.

6. The method of claim 5, wherein the plurality of mutually different playlists are derived from a single, periodically updated playlist for the live media stream.

7. The method of claim 5, wherein at least one of the playlists comprises a closed playlist.

8. A method of displaying a live media stream at a client, in which the media stream is stored on a server as a plurality of discrete media files, and a playlist is provided to the client indicating which media files are required for output of a specific part of the media stream; the method comprising:
requesting access at a client to a previous part of the live media stream,
receiving a customised playlist for the previous part, and receiving the previous part.

9. The method of claim 8, wherein the request relates to a previous time point within the live media stream.

10. The method of claim 8, wherein the request relates to a predefined segment within the live media stream.

11. The method of claim 8, wherein the request comprises a search request.

12. The method of claim 8, wherein the request is responsive to a user input.

13. The method of claim 8, including indicating whether a currently displayed part of the live media stream is live, or said previous part.

14. A method of displaying a media event at a client, the media event comprising a primary module having streaming media content and a plurality of secondary modules each having media content, the method comprising:
a. displaying the streaming media content of the primary module simultaneously with a part of the media content of each of the secondary modules, and, in response to user selection of one of the secondary modules,
b. displaying an additional part of the media content of the selected said secondary module.

15. The method of claim 14, wherein in step a the streaming media content of the primary module in displayed as a primary display, and the parts of the media content of each of the secondary modules are displayed as a secondary display.

16. The method of claim 15, wherein the primary display is displayed in a central position, and the secondary display is displayed around the primary display.

17. The method of claim 14, wherein in step b the streaming media content of the primary module is displayed simultaneously with the additional part of the media content of the selected secondary module.

18. The method of claim 17, wherein in step b the streaming media content of the primary module is displayed as a secondary display to the additional part of the media content of the selected secondary module.

19. The method of claim 14, further including sharing with another user the media content of at least one of the secondary modules.

20. The method of claim 14, further comprising:
c. in response to a further user selection, displaying an additional part of the media content of another selected secondary module.

21. The method of claim 14, wherein said media event is selected by the user from a display of a plurality of media events.

22. The method of claim 21, wherein the plurality of media events are displayed in a timeline.

23. The method of claim 21, wherein the plurality of media 5 events are displayed in a grid.

24. The method of claim 1, in which the media is streamed using a nonstreaming-specific transfer protocol.

25. A computer program product comprising program code means arranged to perform the method of claim 1.

26. Apparatus arranged to perform the method of claim 1.

27. A memory apparatus configured to store media data structure comprising a primary module and one or more associated secondary modules, the primary module comprising streaming media content and associated metadata, and each secondary module comprising media content associated with the primary module.
